(19) United States
(12) Patent Application Publication
(10) Pub. No.: US 2018/0293578 A1
(43) Pub. Date: Oct. 11, 2018

(54) SYSTEM AND METHODS FOR IMPLEMENTING SECURE FINANCIAL TRANSACTIONS

(71) Applicant: BLOSSOM LLC, ST. LOUIS, MO (US)

(72) Inventors: JOSEPH OWEN GARDNER, ST. LOUIS, MO (US); CHRISTOPHER WAYNE MERTENS, ST. LOUIS, MO (US)

(21) Appl. No.: 15/948,277

(22) Filed: Apr. 9, 2018

Related U.S. Application Data
(60) Provisional application No. 62/483,312, filed on Apr. 7, 2017.

(51) Int. Cl. G06Q 20/40; G06Q 20/38

(52) U.S. Cl. CPC G06Q 20/401; G06Q 20/382

(57) ABSTRACT

A system and related methods for securely processing financial transactions is described using a data communications network connecting a plurality of various types of nodes that transmit and receive encrypted data. User and vendor nodes are provided for purchasers and vendors to interact with the system. Communication nodes facilitate data transmission between the other nodes in the system.

This application claims priority to U.S. Provisional Patent Application No. 62/483,312, filed Apr. 7, 2017, the entirety of which is incorporated by reference herein.

### FIELD OF THE INVENTION

The invention relates generally to the field of systems and methods for processing financial transactions. More specifically, the invention relates to systems and methods for securely processing financial transaction using a digital network.

### SUMMARY OF THE INVENTION

The invention comprises a system for securely processing financial transactions. In one embodiment, the system is formed from at least one communication node, or beacon, connected to a data communications network, at least one user node capable of being activated by a user, at least one vendor node capable of interacting with a vendor's point of sale systems, and at least one institution node capable of interacting with the transaction processing systems of a financial institution.

In embodiments of the system, the nodes are capable of securely encrypting data for transmission between the nodes over the data communications network. The beacons send and receive encrypted data to and from user nodes, vendor nodes, and institution nodes to facilitate the processing of a financial transaction.

The user nodes receive input from a user to initiate a transaction and send and receive encrypted data to and from one or more beacons. The user node may comprise a mobile phone, a tablet device, a general purpose computer, a proprietary hardware device, or any similar device capable of accepting user input and communicating data over a data communications network.

The vendor nodes send and receive data from one or more beacons, and prompt and receive input from point-of-sale personnel to enter and confirm a financial transaction. The vendor node may comprise a mobile phone, a tablet device, a general purpose computer, a proprietary hardware device, a point of sale device, or any similar device capable of prompting a user for information, accepting input data in response, and communicating data over a data communications network.

The institution nodes send and receive data from one or more beacons, and may interact with one or more financial processing systems operated by a financial institution. The institution node may comprise a general purpose computer or proprietary hardware device capable of communicating with the beacons over a data communications network. The financial processing systems may comprise a credit card processing system, an online payments solution system, an automated clearing house, or a bank's internal financial transfer mechanisms.

In some methods of using an embodiment of the system, a user initiates a financial transaction using the user node. The user node encrypts the data for the transaction and transmits it to a communications node, or beacon, over the data communications network. Upon receipt, the beacon decrypts a portion of the data to determine where to route the data. The beacon then may transmit the data over the data communications network to a vendor node.

Upon receipt of the data by the vendor node, it may decrypt all or a portion of the data and provide that data to a vendor personnel or to a vendor point of sale system to authorize the financial transaction. Upon completion of the authorization process, the vendor node encrypts the data and transmits it to a communication node, which decrypts a portion of the data, determines where to route the data, and transmits the encrypted data on to another communication node or to a financial institution node.

The financial institution node then decrypts the data and proceeds to complete processing of the financial transaction. This may require the financial institution to invoke various other financial transaction processing systems to accomplish a transfer of money between the accounts of the user and those of the vendor. Such financial transaction processing systems may include credit card processing systems, an online payments solution systems, an automated clearing house, or a bank's internal financial transfer process, among others. Upon completion or failure of the financial transaction, the financial institution node may encrypt data regarding the status of the transaction and transmit it to a user node via one or more communication nodes.

In some embodiments of the system, the nodes may utilize improved encryption technologies to encrypt the transaction data for secure transmission over a data communications network that may not be secure itself.

### BRIEF DESCRIPTION OF THE DRAWINGS

FIG. 1 is a schematic view of an embodiment of the system of the present invention.

FIG. 2 is a schematic view of a method of using an embodiment of the system of the present invention.

FIG. 3 is a schematic view of another method of using an embodiment of the system of the present invention.

### DETAILED DESCRIPTION

The systems and methods as disclosed in reference to the embodiment depicted in the figures provides an improved system and methods for securely processing financial transactions using a data communications network.

In various embodiments, the system comprises a plurality of nodes of various types that perform diverse functions to operate the system. Some nodes act as communication nodes, or beacons, that operate to route encrypted data between the other nodes of the system in a secure manner. Such nodes only access a portion of the data in the encrypted transmission sufficient to determine the routing of the data through the system. Other nodes interact with a consumer or user who desires to initiate or confirm the processing of a financial transaction such as a purchase transaction. The user of the “user node” may be referred to as a purchaser of goods or services. Other nodes interact with the point of sale systems of a vendor to receive and confirm a transaction initiated by a user. Other nodes interact with financial institutions to facilitate the transfer of funds between accounts to complete the financial transaction.

In some embodiments of the system, the communication nodes may be managed as a group by a service provider that supports and facilitates operation of the system.

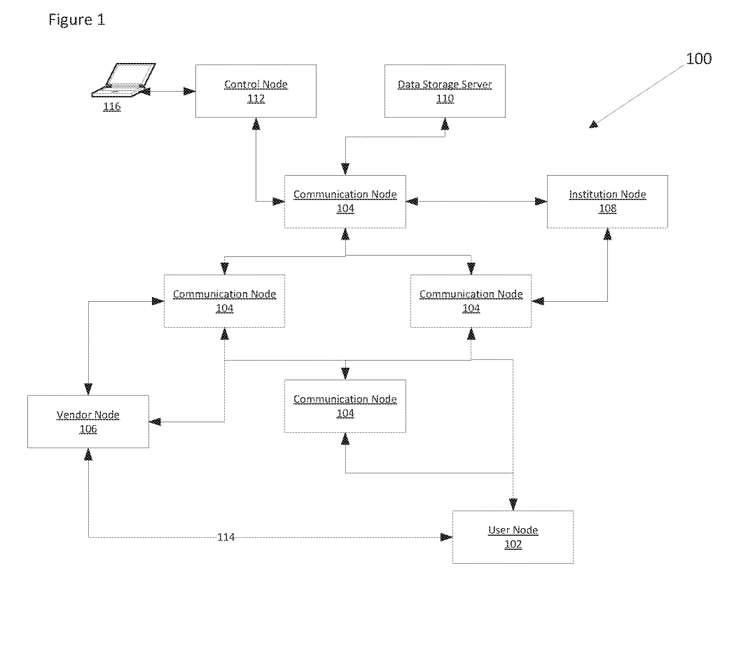

Referring now to FIG. 1, a schematic view of one embodiment of the system 100 of the present invention is depicted. A user node 102 is provided for a user to interact with the system 100 to initiate and complete financial transactions.

In some embodiments of the present invention, the user node 102 may comprise a dedicated hardware device executing a software program for connecting to the other components of the system 100 through a data communications network. In some embodiments, of the data communication network is a combination of interconnected networks, including, without limitation, local area networks, wireless networks, cellular networks, wide area networks, and global communications networks.

The various nodes of the system 100 communicate by transmitting and receiving data over the data communications network. In some embodiments of the system 100, the data communications network provides all network layers of the Open Systems Interconnection Model, and the nodes comprising the system 100 communicate by interacting with the application layer of the network technology used for a specific data communications network. As described below, the data used by the system 100 is encrypted by the node before transmission to another node, so that the data is secure while in transit between nodes despite any vulnerabilities of the underlying data communication network technology.

In other embodiments of the system, the user node 102 is a software program installed on a user device, including without limitation, devices such as mobile phones, tablet devices, mobile computers, or any other device capable of connecting to a data communication network. The software program in combination with the user device can serve as the user node 102. In other embodiments of the system, the user node 102 may be a chip card containing a chip that provides the functions of the user node 102 via a “chip” reader on a point of sale device. In other embodiments, the user node 102 may be a software library embedded into a third party software package or hardware component. For example, the user node 102 may be incorporated into a web site by utilizing library routines that provide an interface between the web site and the system to allow a user to process a transaction from the web site. Similarly, third party hardware devices may incorporate the functionality of the user node 102 utilizing firmware library packages or even discrete hardware modules that embody the user node 102 functionality.

The user node 102 may use a unique and secure identifier to uniquely identify the user node to the system 100. The identifier may be provided by the system 100 or may be selected from another unique identifier available to the user node 102. Such other identifiers may include, but are not limited to, the hardware identifiers used by technologies such as Bluetooth, near field communications networks, radio frequency identification, or other similar hardware identifiers.

Once a user node 102 is securely identified to the system 100, the node 102 is able to communicate securely with communication nodes 104 by transmitting data over the data communications network. One or more of the communication nodes, or beacons, 104 are provided to facilitate the secure transmission of data from the user node to other end nodes of the system, such as transmission from a user node 102 to a vendor node 106 or an institutional node 108. The communication nodes 104 receive and send secure, encrypted data to and from other nodes 102, 104, 106, and 108. When a communication node 104 receives encrypted data from another node, it decrypts a subset of the encrypted data to determine the appropriate node to receive the data next in the chain of transmission to its final destination. In some embodiments, the communications nodes are referred to as portals or access servers.

In some embodiments of the system, the communications nodes 104 may utilize a distributed ledger to allow multiple nodes to access and update transaction data for various transactions. Some embodiments of the system utilize a blockchain-based technology to maintain a distributed ledger.

Some embodiments of the system utilize “smart contracts” to implement the functionality of the system. Smart contracts are typically used in conjunction with blockchain technology. Smart contracts are executable computer programs that are compiled into the data in a block in the blockchain by the developers of the smart contract. Once the smart contract has been deployed into the blockchain users of the blockchain may execute the smart contract with confidence that it has not been modified by a malicious third party. These executable computer programs are referred to as “smart contracts” because they may be used to represent and implement agreements between various parties, however, they do not have to represent contractual arrangements.

A software developer develops the smart contract by writing program code using a scripting language such as JavaScript, Solidity, or other scripting languages, or an object coding language, such as Java, or a machine coding language such as C or C++. When a “smart contract” is deployed into the blockchain, the program code is processed into a block by one of the contributors to the system just as any other transaction on the blockchain. The process of deploying the smart contract may include compiling the program code into bytecode, object code, binary code, or some other executable form. When the smart contract is successfully deployed into the block chain it is assigned an address just as any other blockchain transaction. This address is used to access the smart contract and execute the functionality provided in it. Typically, an Application Binary Interface (ABI) information, similar to an application programming interface, is provided to a user of the contract, or the software that interfaces with the contract (such as a wallet application) so that the user can interact with the various functions of the smart contract. The ABI describes the various functions and methods provided as part of the smart contract so that they can be accessed by the user or the user's software. In some embodiments of the system described herein, the nodes in the system access smart contracts compiled into a distributed ledger system.

The system 100 includes one or more vendor nodes 106 at locations where a user may wish to purchase a product or a service. The vendor node 106 is able to communicate with the system 100 by connecting to communication nodes 104 over the data communications network. In some embodiments, these nodes 106 may be implemented as proprietary hardware and software solutions that interact with the vendor's point of sale systems. In other embodiments, the nodes 106 may comprise proprietary software executing on a general purpose computing device or a point of sale device provided by the vendor. A vendor must establish an account within the system 100, and the node 106 utilizes credentials issued to that account to authenticate itself to, receive authorization from, and connect to the system 100.

In some embodiments, the node 106 will incorporate or have access to wireless communications, such as Wi-Fi, RFID, NFC, Bluetooth, or other wireless technologies. These technologies may be used to establish a direct connection 114 between a user node 102 and a vendor node 106 during the completion of a transaction.

In many embodiments, the vendor node 106 will comprise a typical retail point of sale device used by a retail merchant. However, in some embodiments of the system, the vendor may be selling property such as securities, stock, real property, alternative currencies such as bitcoin, or other such property. Such vendors may also utilize the system to transfer funds, and potentially to consummate the conveyance of the assets (e.g. causing the transfer of stock on the books of the company, or causing the recording of a conveyance of other property).

In some embodiments, the system 100 includes one or more institutional nodes 108 provided by financial institutions to communicate with the system 100 to process financial transactions. Similar to the other nodes in the system 100, the institutional node is able to communicate with the system 100 by connecting to communication nodes 104 over the data communications network. In some embodiments, these nodes 108 may be implemented as proprietary hardware and software solutions that interact with the financial institution's systems to approve and clear financial transactions. In other embodiments, the nodes 106 may comprise proprietary software executing on a general purpose computing device provided by the financial system, such as a server computer operated by the financial institution.

The financial institution may be a bank or another type of institution that facilitates financial transactions. For example, and without limiting the types of institutions that comprise financial institutions, such institutions include banks, credit card processing companies, automated clearinghouses, and online payment solutions providers. Since often the parties to a financial transaction may utilize more than one depository bank to hold funds in their accounts, a single bank serving as a financial institution node could not process the transaction on its own internal systems. As a result, the financial institution may receive a financial transaction from the system 100 and then process it using a payment processing system designed to authorize and clear financial transactions between depository banks.

In some embodiments of the system 100, one or more data storage servers 110 are provided to receive, store, and retrieve data upon request from other elements of the system 100. The data storage servers 110 store data and content that is needed for some operations performed by the system 100, however, basic transaction processing functions may continue even if no data storage server 110 is available to provide additional data needed for additional system functions. Data storage servers 110 are designed to provide a fault-tolerant data storage service to the system 100, and may include redundant, mirrored, or distributed databases and servers to maximize data availability. Other elements of the system may submit data to or retrieve data from data storage servers 110 as necessary for their operations.

In other embodiments of the system 100, one or more control nodes 112 are provided for monitoring and controlling the operations of the other elements of the system 100. The control nodes 112 are not directly involved in the processing of transactions, and do not access or utilize user or financial information, except as may be necessary to monitor the performance of the system. The control nodes 112 may take various actions with respect to the other nodes in the system, including shutting down, restarting, taking offline, activating, upgrading, adding, removing, and performing maintenance on the various other components of the system. In some embodiments of the system 100, the control nodes 112 selectively perform administration tasks to minimize the impact on system performance, such as by limiting maintenance tasks on high traffic or busy components of the system.

The control nodes 112 may be accessed by system administrators via one or more workstation 116 to monitor the system 100, upload software updates, apply configuration changes, or take other system administration actions. System administrators may access the control nodes 112 to cause the control nodes to take further action with respect to the other elements of the system, such as disseminating software upgrades or performing other maintenance.

The interoperability and self-reorganizing features of the system 100 allow the various components in the system to be added, removed, updated, shutdown, taken offline, restarted, reconfigured, maintained, and otherwise disconnected from the system without impacting the overall functionality of the system 100.

The various elements of system 100 create a self-governing and dynamic network of communicating nodes. The failure, shutdown, or unavailability of any one element or node will not cause a failure of the system 100. Instead the system 100 automatically reconfigures to route transactions and information around the missing element or node.

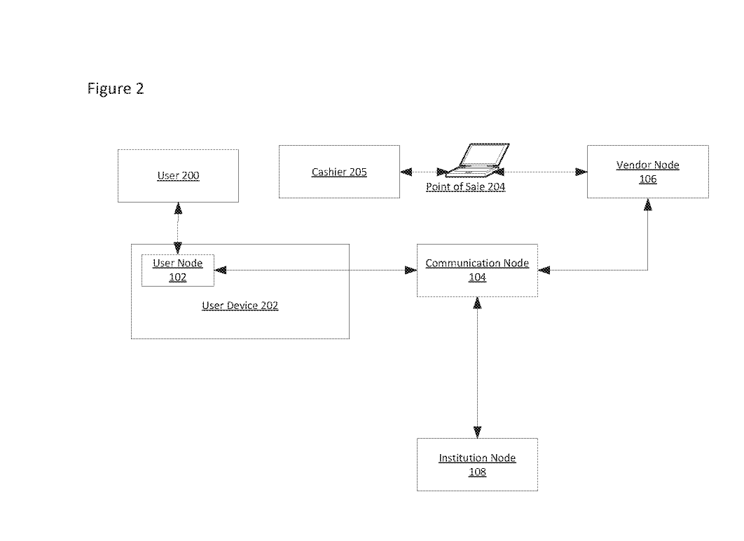

Referring now to FIG. 2, a schematic view of one method of using an embodiment of a system of the present invention is depicted. The process begins with a user 200 that desires to make a purchase or complete another financial transaction using the system of the present invention. In one embodiment of the system, the user determines to authorize a transaction and activates a user node 102 of the system which connects to one of the secure communication nodes 104 provided as part of the system. The user node 102 submits transaction related data through a device 202, such as a mobile phone or a tablet device connected to the data communications network via a wireless technology, to a communication node 104 in a secure, encrypted form. The communication node 104 decrypts a portion of the data to identify the appropriate node to which it should transmit the information. The communication node 104 that receives the data from the user node 102 transmits the data on either to another communication node 104 or to a vendor node 106. The data eventually is transmitted to the vendor node 106, though it may be forwarded by more than one communication node 104 before it is transmitted to the vendor node 106.

The vendor node 106 at the point of sale 204 receives the secure, encrypted data from a communications node 104 and decrypts the data. The vendor node 106 or a connected point of sale device displays the transaction information to a cashier or other vendor personnel 205 for approval. Once the cashier confirms the transaction, vendor node 106 receives the confirmation, encrypts and sends the confirmed transaction data to a communications node 104, and it is routed via one or more nodes 104 to the user node 102 for final authorization by the user. Once the final authorization is received from the user, the authorized transaction data is transmitted to a communications node 104.

After final authorization by the user through user node 102, the transaction data is encrypted and transmitted via one or more communication nodes 104 to an institution node 108. The financial institution may be a bank, an automated clearinghouse, a credit card processing company, an online payment system, or any other institution or system that processes and clears financial transactions between one or more parties. Once the transaction is processed by the financial institution, the institution node 108 encrypts data confirming the transaction and forwards the secure information back through one or more communication nodes 104 to either the user node 102, the vendor node 106, or both.

The system 100 utilizes data encryption to secure all transaction data as it is transmitted between the various nodes in the system. In some embodiments, the system utilizes an improved method of encrypting data, such as Cryptolabyrinthium (CRL) encryption technology described in U.S. Pat. No. 9,152,801 and U.S. Pat. No. 8,897,440. The processing time for that technology increases rapidly as the key used to encrypt the data increases in length. Since a longer key length increases the security of the encryption, an improved encryption technology provides for reduced processing times for longer key lengths. Graphs 302 and 304 depict the relationship between processing time and key length for two implementations of the CRL encryption technology. As can be seen from the slope of the graphs 302 and 304, the processing time for CRL encryption increases much more slowly as the key length increases than prior technologies. The relationship between graphs 300, 302 and 304 also depict that the CRL technology may utilize a much longer key length for a given processing time than can be used in the current encryption technologies. In other embodiments of the system, alternative encryption technologies may be utilized instead of CRL.

In systems utilizing the CRL encryption technology or similar encryption technologies, a shared key is utilized by the encryption and decryption processes. The CRL system utilizes a series of byte codes include both the data to be encrypted, as well as a set of meta byte codes that represent reversible operations. This allows a specific implementation of the encryption to not only utilize a lengthy key to encrypt the data, but to include other reversible operations into the encryption and decryption process to further resist attempts at unauthorized decryption. Each implementation of the CRL encryption generates its own set of meta byte codes to represent its unique set of reversible operations. Without access to this set of meta byte codes and the mapping to reversible operations, even access to the key for decryption will not allow successful decryption of the encrypted data. This encryption technology creates multiple layers of security, allowing larger encryption keys and sets of meta byte codes that can be replaced as necessary if the current implementation is determined to be compromised in some way.

In some embodiments of the system of the present invention the encryption technology is utilized in a specific manner to greatly increase the security of the system. Since the advanced encryption technologies utilized by the system are capable of encrypting and decrypting data much faster than current industry standard encryption technologies, any node or user that connects to the system is required to complete an encryption challenge within a specified time window to validate that they possess the correct credentials. If the user or node attempting to connect to the system fails to complete the challenge within the specified time, it is inferred that the user or node does not possess the correct credentials and should not be granted access to the system.

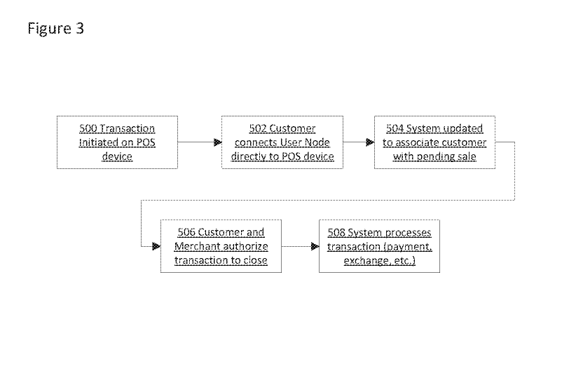

FIG. 3 depicts a schematic view of an additional method of using an embodiment of the system of the present invention. In this method of using the system, a transaction is initiated at step 500 on the point of sale device such as a vendor node 106 utilized by a merchant. The transaction is logged by the system as a pending, current sale for the merchant's account with no assigned customer. In step 502, the customer utilizes a user node 102, in any form, to connect directly to the vendor node 106 via any secure data connection technology, such as Wi-Fi, NFC, Bluetooth, or other similar technologies that exist now or may be developed. The customer's account with the system is then associated with the pending, current sale in step 504 and all relevant transaction details are provided to the system. The relevant transaction details include payment details from the customer, such as debit or credit card accounts, wire transfer details, gift card details, online payment system account details, or information on other payment systems for clearing a completed transaction. In step 506, both customer and merchant authorize the transaction to complete based on the parameters provided to the system, the system is updated. Upon system update, the systems completes the processing of the payment in step 508, such as by utilizing an institution node 108 to close a transaction. Step 508 may include transfer of funds, but may also include the transfer of other assets such as securities, real property, or other transferrable assets.

In a preferred embodiment of the system, all transaction data is maintained in confidentiality by the system. In some embodiments of the system, users of the system may agree to allow the disclosure or transfer of their transaction data to third parties. Some user may decide to release all of their transaction data to the public as a means of establishing value or setting market price for some good or service. Other users may decide to sell access to their transaction data to third parties for the purpose of data mining, targeted marketing, consumer intelligence, or other similar uses.

In some embodiments of the system, transaction data may be maintained on a distributed ledger technology, such as blockchain-based technology. In such embodiments the data may be encrypted to prevent unauthorized access to information or it may be anonymized so that third parties can view the transaction information without being able to attach the transaction to specific parties. The data stored by the system may include successful or valid transactions as well as unsuccessful or failed transactions.

In some embodiments of the system, a user may utilize artificial intelligence (AI) agents to process their personal data and interact with the system based upon their data and rules set by the user. Such rules may allow the AI agents to perform transactions on the network on behalf of the user, including auto-trading, suggested goods or services that may be of interest to the user, connecting the user with other merchants or users who may have goods or services that would add value to each other, identify improved supply channels for businesses, identify cost savings, market information and trends, and other similar services.

In some embodiments of the present invention, the system may be generalized to support a barter transaction whereby the “payment” for an item is not necessarily money. In some embodiments, a “customer” may pay for an item with another item that has a similar value as determined by the “merchant”. Thus, the user and the vendor may determine a transaction parameter such that no money is exchanged during a transaction. Instead, for example, a certain number of shares of stock in a publicly traded company could be transferred by the system to the merchant in return for a certain number of items sold by the merchant.

When transaction data is made available to the public in detail, or even in summarized forms, the system can use the data to provide relative measures of value between various types of goods or other items, even if no currency is used to purchase the goods. For example, if customers in a certain area are typically buying a quantity of one of item A for a quantity of two of item B, and item B is typically traded for a quantity of three of item C, then a trader could be confident in offering a quantity of six of item C to purchase one of item A. Thus a “relative value” of a good or service is determined with reference only to another good or service. This “relative value” can be calculated to any number of links in a “chain of associations” between items for sale. Simulations based on expected values (using intrinsic and subjective valuations) can be used to find the expected relative values for goods and services in an simulated economy.

In another embodiment of the system, the system may be generalized to model and manage other types of systems beyond financial transactions. Other systems that have nodes and connections between nodes may also be modeled and managed by the monitoring system that controls the financial transaction embodiments of the system. For example, such systems may be used to simulate and manage airport operations, power grids, piping systems, alternative computing systems.

In another embodiment of the system, a customer may also be allowed to claim a check without the interaction of the vendor. In such an embodiment, the vendor will have created a transaction with one or more charges associated with it and have associated it with the user. The user may then access the invoice for the transaction, and claim it. The user may then pay a portion of the ticket and allow other users to pay a portion, or pay the entire check themselves. In some embodiments of the system, the vendor initiates a smart contract referencing the services rendered, goods provided, or other item of value. The user interacts with the smart contract to pay some or all of the ticket. The smart contract may then automatically initiate payment through some payments system such as a credit or debit card transaction, an ACH transaction, or an online payment provider.

In some embodiments of the system, users may incorporate the time value of money into their transactions using the system. For transactions taking place over time, or with payment or performance by one party before the other, the users may agree upon a discount rate to apply to the transaction, or the system may provide or suggest a discount rate based upon transaction and market data from other transactions. The system may then utilize the net present value of some future single or series of payment or performance events as consideration of a current payment. The system may provide automated functions to transfer the future payments from one party to another.

In some embodiments of the system, multi-factor authentication protocols before granting access to a node. In various embodiments, the factors used to secure the system may include passwords or other secret information, token-based factors such as one-time passcode generators, physical tokens (access cards, etc.), biometric factors such as fingerprints, retina scans, or facial or voice recognition, or other such technologies that may be developed in the future.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A method for facilitating a transaction between vendors and purchasers of goods or services, the method comprising:
providing a vendor node utilized by the vendor of goods or services;
providing a user node utilized by the purchaser of goods or services;
providing at least one communications node capable of transmitting and receiving data to and from the at least one vendor node and the at least one user node via a data communications network;
transmitting transaction data regarding the transaction from the user node to the at least one communication nodes;
transmitting the transaction data regarding the transaction from the at least one communications nodes to the vendor node;
receiving a confirmation of the transaction data at the vendor node;
transmitting the confirmation of the transaction data from the vendor node to the user node;
receiving an authorization of the transaction data from the user at the user node; and
transmitting the authorization of the transaction data to the at least one communications node.

2. The method of claim 1 further comprising the step of:
transmitting the transaction data from the at least one communications node to an institution node for processing of a payment.

3. The method of claim 1 further comprising the step of:
storing the transaction data in a distributed ledger.

4. The method of claim 3 wherein the steps of receiving a confirmation and receiving an authorization are implemented as a smart contract stored on the distributed ledger.

5. The method of claim 1 wherein the step of receiving an authorization of the transaction at the user node comprises confirming only a portion of the transaction.

6. The method of claim 1 wherein the transaction is a barter transaction.

7. A method for facilitating a transaction between a vendor of goods and services and a purchaser of goods and services, the method comprising the steps of:
providing a vendor node utilized by the vendor of goods or services;
providing a user node utilized by the purchaser of goods or services;
providing at least one communications node capable of transmitting and receiving data to and from the at least one vendor node and the at least one user node via a data communications network;
transmitting transaction data regarding the transaction from the vendor node to the at least one communication nodes;
transmitting the transaction data regarding the transaction from the at least one communications nodes to the user node;
receiving a confirmation of the transaction data at the user node;
transmitting the confirmation of the transaction data from the user node to the vendor node;
receiving authorization of the transaction data from the vendor at the vender node; and
transmitting the authorization of the transaction data to the at least one communications node.

8. The method of claim 7 further comprising the step of:
transmitting the transaction data from the at least one communications node to an institution node for processing of a payment.

9. The method of claim 7 further comprising the step of:
storing the transaction data in a distributed ledger.

10. The method of claim 9 wherein the steps of receiving a confirmation and receiving an authorization are implemented as a smart contract stored on the distributed ledger.

11. The method of claim 7 wherein the step of receiving a confirmation of the transaction at the user node comprises confirming only a portion of the transaction.

12. The method of claim 7 wherein the transaction is a barter transaction.
